(19) United States
(12) Patent Application Publication
(10) Pub. No.: US 2026/0302321 A1
(43) Pub. Date: Oct. 1, 2026

(54) METHOD FOR MANUFACTURING BATTERY

(71) Applicant: HONDA MOTOR CO., LTD., Tokyo (JP)

(72) Inventor: Takeshi YOKOMIZO, Saitama (JP)

(73) Assignee: HONDA MOTOR CO., LTD., Tokyo (JP)

(21) Appl. No.: 19/578,911

(22) Filed: Mar. 26, 2026

(30) Foreign Application Priority Data
Mar. 28, 2025 (JP) 2025-055992

(51) Int. Cl. H01M 10/04; H01M 4/38; H01M 10/0525; H01M 50/211; H01M 50/262; H01M 50/289

(52) U.S. Cl. CPC H01M 10/0481; H01M 4/382; H01M 4/386; H01M 10/0525; H01M 50/211; H01M 50/262; H01M 50/289

(57) ABSTRACT

A method for manufacturing a battery includes laminating the plural cells and the plural cushioning members as defined herein, and when laminating the plural cells and the plural cushioning members, the plural cells and the plural cushioning members are divided into plural groups including a first group including one or more of the cells and two or more of the cushioning members and a second group including one or more of the cells and two or more of the cushioning members, the cells and the cushioning members in the first group are laminated along the guide, a guide module is connected to the guide to extend the guide in the laminating direction, and the cells and the cushioning members in the second group are overlapped and laminated on the cells and the cushioning members in the first group along the extended guide.

### CROSS-REFERENCE TO RELATED APPLICATION

This application is based on and claims priority under 35 USC 119 from Japanese Patent Application No. 2025-055992 filed on Mar. 28, 2025.

### TECHNICAL FIELD

The present invention relates to a method for manufacturing a battery.

### BACKGROUND ART

In recent years, researches and developments have been conducted on a secondary battery which contributes to improvement in energy efficiency in order to allow more people to have access to affordable, reliable, sustainable and advanced energy.

A battery cell pressurizing device described in Patent Literature 1 includes a plurality of battery cells arranged in a thickness direction, a plurality of pressurizing bags disposed between the plurality of battery cells and capable of pressurizing the battery cells by a pressurized fluid supplied to an inside, and a housing that accommodates the plurality of battery cells and the plurality of pressurizing bags. The housing includes guide shafts inserted into guide holes provided at four corners of each of the pressurizing bags, and holds the pressurizing bags slidably in the thickness direction.

In a fuel cell manufacturing method described in Patent Literature 2, a cylindrical intermediate adapter is sequentially fitted into through holes of a unit cell and a separator plate to form a unit block. Next, a plurality of unit blocks are laminated by inserting a shaft into through holes of the intermediate adapters, and the plurality of laminated unit blocks are fastened with the shaft as an axis.

Patent Literature 1: JP2019-175800A

Patent Literature 2: JP2001-057226A

### SUMMARY OF INVENTION

For example, in a battery to be mounted on an electric vehicle such as an electric automobile, the number of laminated cells tends to increase in response to a request for a large capacity and/or a high voltage of the battery. As the number of cells increases, when the laminated cells and cushioning members sandwiching the cells are compressed, the cells and the cushioning members in an intermediate portion in a laminating direction are likely to be displaced in a direction perpendicular to the laminating direction.

Although the positional displacement can be prevented by using a guide, when the number of laminated cells is large, a guide having a corresponding length is required. When the guide is inserted into a hole of a cell and/or a cushioning member, it takes time and effort particularly to move the cell and/or the cushioning member disposed on a lower layer side along the guide. An object of the present invention is to improve assemblability of a battery.

An aspect of the present invention is a method for manufacturing a battery in which a plurality of cushioning members and a plurality of cells each disposed between adjacent two of the cushioning members are laminated, the method including:

laminating the plurality of cells and the plurality of cushioning members by engaging a guide-engaging portion of each of the cells and a guide-engaging portion of each of the cushioning members with a guide extending in a laminating direction of the plurality of cells and the plurality of cushioning members, in which

when laminating the plurality of cells and the plurality of cushioning members, the plurality of cells and the plurality of cushioning members are divided into a plurality of groups including a first group including one or more of the cells and two or more of the cushioning members and a second group including one or more of the cells and two or more of the cushioning members, and

the cells and the cushioning members in the first group are laminated along the guide,

a guide module is connected to the guide to extend the guide in the laminating direction, and

the cells and the cushioning members in the second group are overlapped and laminated on the cells and the cushioning members in the first group along the extended guide.

According to the present invention, assemblability of the battery can be improved.

### BRIEF DESCRIPTION OF DRAWINGS

FIG. 1 is a front view schematically showing an example of a battery for illustrating an embodiment of the present invention.

FIG. 2 is a plan view of a cell in the battery of FIG. 1.

FIG. 3 is a plan view of a cushioning member in the battery of FIG. 1.

FIG. 4 sequentially shows an example of a method for manufacturing the battery of FIG. 1.

FIG. 5 sequentially shows the example of the method for manufacturing the battery of FIG. 1.

FIG. 6 sequentially shows the example of the method for manufacturing the battery of FIG. 1.

FIG. 7 sequentially shows the example of the method for manufacturing the battery of FIG. 1.

FIG. 8 sequentially shows the example of the method for manufacturing the battery of FIG. 1.

FIG. 9 sequentially shows another example of the method for manufacturing the battery of FIG. 1.

FIG. 10 sequentially shows the other example of the method for manufacturing the battery of FIG. 1.

FIG. 11 sequentially shows the other example of the method for manufacturing the battery of FIG. 1.

### DESCRIPTION OF EMBODIMENTS

An example of a battery and a method for manufacturing the battery, which illustrate an embodiment of the present invention will be described with reference to the accompanying drawings.

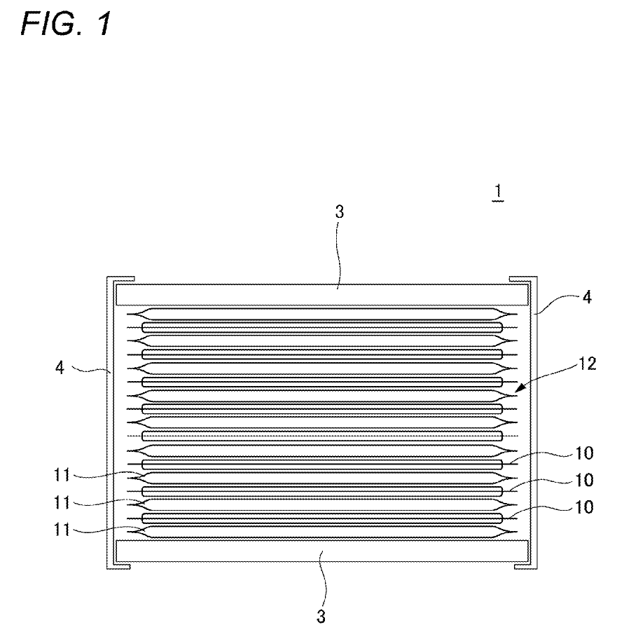

A battery 1 shown in FIG. 1 includes a plurality of cells 10 and a plurality of cushioning members 11. The cells 10 and the cushioning members 11 are flat or planar, and are laminated in a thickness direction. Each of the cells 10 is sandwiched between two adjacent cushioning members 11. The battery 1 further includes a set of end plates 3 that sandwich a laminate 12 of the plurality of cells 10 and the plurality of cushioning members 11 in a laminating direction, and frames 4 that restrain the set of end plates 3 to each other. The frames 4 fix an interval between the set of end plates 3.

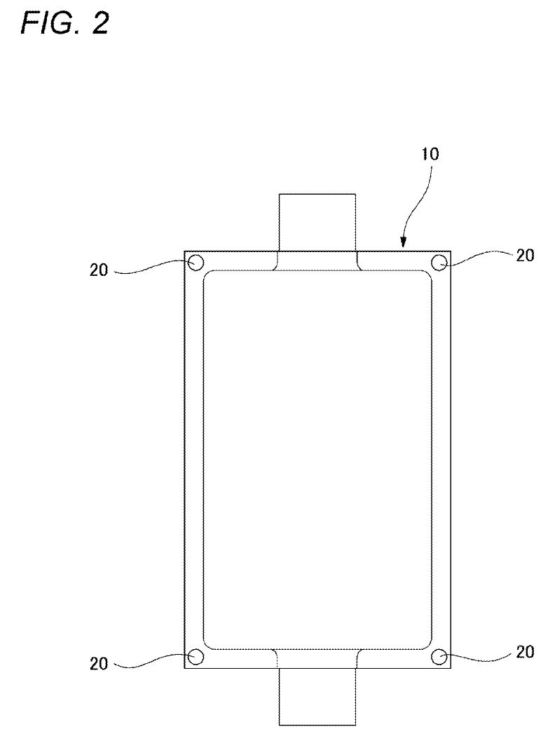

FIG. 2 shows an example of the cell 10. The cell 10 is a so-called laminate cell in which a positive electrode, a negative electrode, a separator, and an electrolyte are sealed in a laminate film pack. In general, as compared with a can cell in which a material of the positive electrode or the like is sealed in a cylindrical or rectangular metal container, the laminate cell is high in energy density per volume and excellent in heat dissipation.

A plurality of guide holes 20 are provided in an outer peripheral edge portion of the cell 10. In an example shown in FIG. 2, the cell 10 is formed in a substantially rectangular shape when viewed in a thickness direction, and the guide holes 20 are provided at four corners of the cell 10. The cell 10 is not limited to the rectangular shape, and the positions of the guide holes 20 are not limited to the four corners. A holder that holds the cell 10 may be provided, and the guide holes 20 may be provided in the holder.

The cell 10 is, for example, a lithium-ion battery or nickel-hydrogen battery using a liquid electrolyte, or an all-solid-state battery using a solid electrolyte. In the all-solid-state battery, the solid electrolyte also serves as the separator. In general, as compared with a lithium-ion battery or the like using a liquid electrolyte, the all-solid-state battery is excellent in temperature resistance and has a long life.

In either a cell using the liquid electrolyte or a cell using the solid electrolyte, a material having an excellent energy density but a large expansion amount, such as metallic lithium, an alloy containing metallic lithium, or silicon (Si), may be used for the negative electrode. For example, on a surface of the negative electrode made of the metallic lithium or the like, lithium is deposited due to repeated charging and discharging. When there is a variation in an in-plane pressure distribution of the cell 10, precipitation of lithium may be biased. The biased precipitation of lithium promotes the precipitated lithium to grow into a protrusion shape, which may reach the positive electrode to cause a short circuit. Therefore, it is required to uniformly pressurize each in-plane location of the cell 10 with an appropriate load.

Further, in the cell using the solid electrolyte, it is important to densify the solid electrolyte and increase adhesion between the electrodes and the solid electrolyte in order to smooth movement of ions between the electrodes. Therefore, it is required to uniformly pressurize each in-plane location of the cell 10 with an appropriate load.

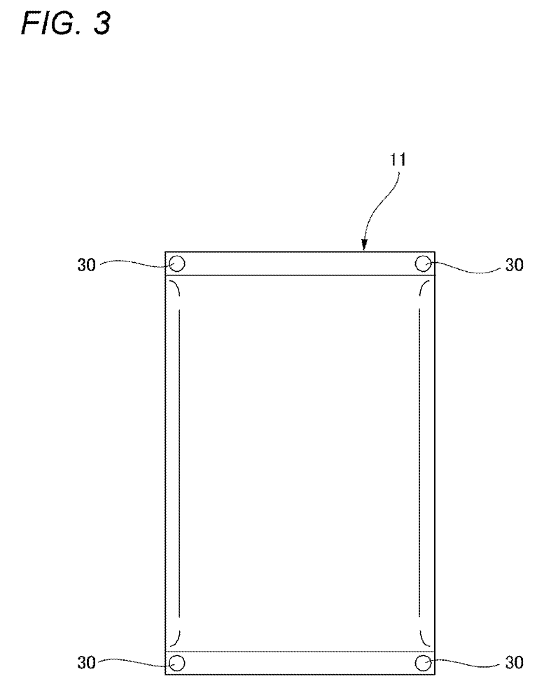

FIG. 3 shows an example of the cushioning member 11. The cushioning member 11 is a pouch in which a fluid such as a gas or a liquid is sealed in a bag-shaped insulating packaging material. Based on isotropy of a fluid pressure inside the cushioning member 11, a load acting on each in-plane location of the cell 10 sandwiched between two adjacent cushioning members 11 is equalized. The cushioning member 11 is not limited to the above-described pouch as long as the cushioning member 11 has cushioning properties and pressure equalization properties.

A plurality of guide holes 30 are provided in an outer peripheral edge portion of the cushioning member 11. In the laminate 12, each of the guide holes 30 of the cushioning member 11 is aligned with a corresponding guide hole 20 among the plurality of guide holes 20 of the cell 10 in the laminating direction. In the example shown in FIG. 3, the cushioning member 11 is formed in a substantially rectangular shape when viewed in the thickness direction corresponding to the substantially rectangular cell 10 shown in FIG. 2, and the guide holes 30 are provided at four corners of the cushioning member 11.

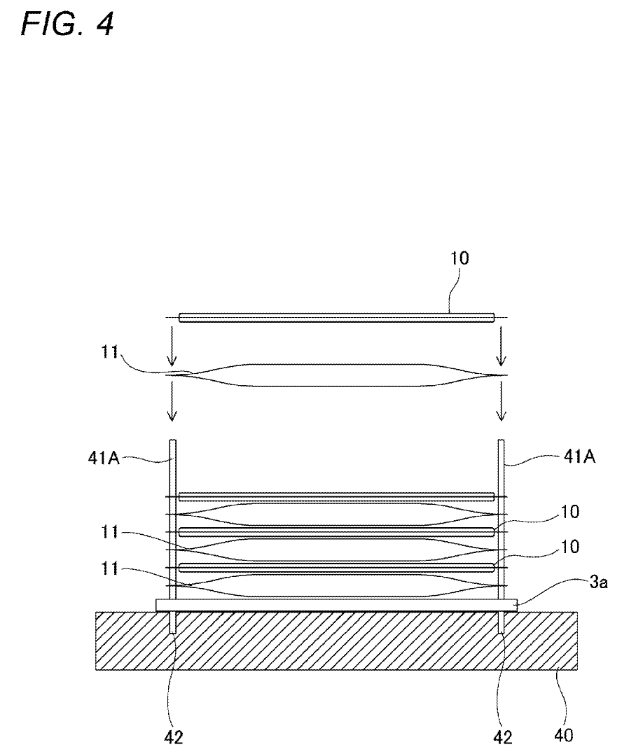

An example of a method for manufacturing the battery 1 will be described with reference to FIGS. 4 to 8. Hereinafter, the laminating direction of the cells 10 and the cushioning members 11 will be described as an upper-lower direction for convenience.

First, the plurality of cells 10 and the plurality of cushioning members 11 are divided into a plurality of groups including a first group and a second group. The first group and the second group each include one or more cells 10 and two or more cushioning members 11. Here, it is assumed that the plurality of cells 10 and the plurality of cushioning members 11 are divided into two groups including the first group and the second group.

As shown in FIG. 4, a lower end plate 3a in the set of end plates 3 is placed on a base 40. The base 40 is provided with a plurality of rod-shaped guides 41A. Each of the guides 41A extends in the upper-lower direction, and a lower end portion 42 thereof is fixed to the base 40. The lower end portion 42 may be fixed so as not to rotate with respect to the base 40, and a fixing method is not particularly limited.

The lower end plate 3a is provided with a plurality of guide holes, and each of the guide holes is aligned in the upper-lower direction (laminating direction) with a corresponding guide hole among the plurality of guide holes 20 of the cell 10 and a corresponding guide hole among the plurality of guide holes 30 of the cushioning member 11. Each of the guides 41A is inserted into a corresponding guide hole among the plurality of guide holes of the lower end plate 3a, and the lower end plate 3a is moved downward from an upper end of each guide 41A along the guides 41A and installed on the base 40.

Then, the cells 10 and the cushioning members 11 in the first group are laminated on the lower end plate 3a. Each of the guides 41A is inserted into the corresponding guide hole among the plurality of guide holes 20 of the cell 10, further inserted into the corresponding guide hole among the plurality of guide holes 30 of the cushioning member 11, and the cells 10 and the cushioning members 11 are moved downward along the guides 41A from the upper end of each guide 41A and are sequentially overlapped on the lower end plate 3a. The guide 41A may or may not be in contact with an edge of the guide hole 20 of the cell 10 and an edge of the guide hole 30 of the cushioning member 11. The number of the cells 10 and the number of the cushioning members 11 in the first group are set according to a length of the guide 41A such that a total thickness of the cells 10 and the cushioning members 11 when not compressed is less than the length of the guide 41A.

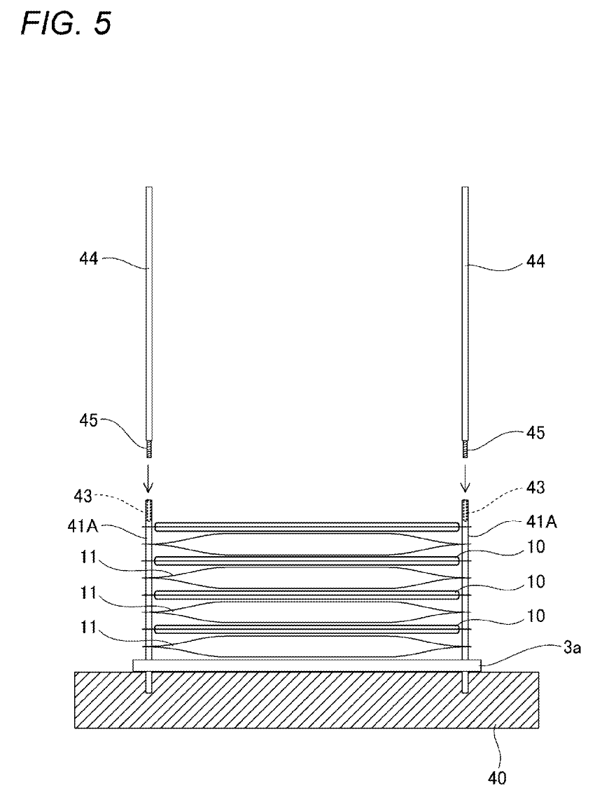

Next, as shown in FIG. 5, a guide module 44 is connected to the upper end portion of each guide 41A. A female thread 43 as an example of a fixing element is formed in an upper end portion of the guide 41A, a male thread 45 as an example of a fixing element is formed in a lower end portion of the guide module 44, and the guide module 44 is connected to the guide 41A by screwing the female thread 43 and the male thread 45. The guide module 44 is integrated with the guide 41A to form a guide 41B extended from the guide 41A. A method of connecting the guide 41A and the guide module 44 is not particularly limited as long as the guide module 44 can be separated from the guide 41A, and the guide 41A and the guide module 44 may be connected by fitting a plurality of convex portions and concave portions extending in a connection direction, such as spline fitting.

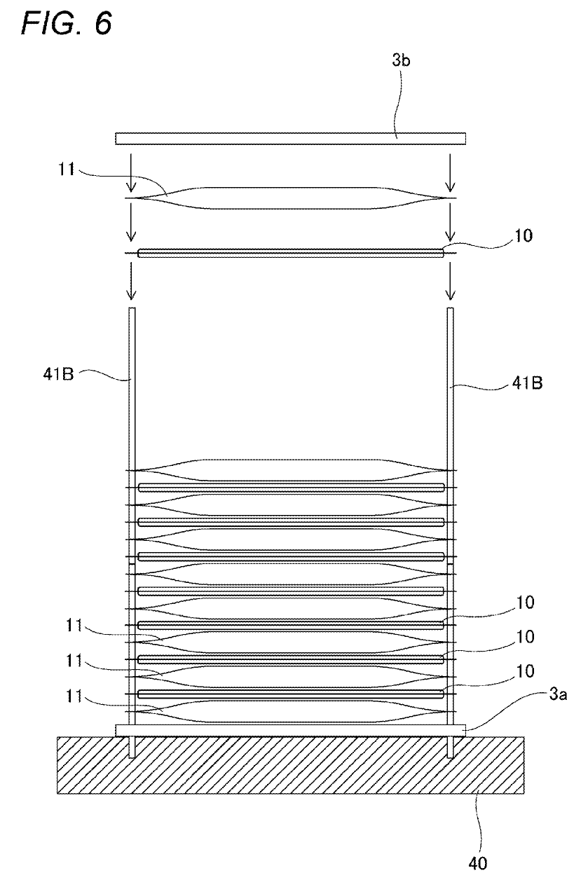

Next, as shown in FIG. 6, the cells 10 and the cushioning members 11 in the second group are overlapped on the laminated cells 10 and cushioning members 11 in the first group. Each of the guides 41B is inserted into the corresponding guide hole among the plurality of guide holes 20 of the cell 10, further inserted into the corresponding guide hole among the plurality of guide holes 30 of the cushioning member 11, and the cells 10 and the cushioning members 11 are moved downward along the guides 41B from an upper end of each guide 41B and are sequentially overlapped on the laminated cells 10 and the cushioning members 11 in the first group. The number of cells 10 and the number of cushioning members 11 in the second group are set according to a length of the guide 41B. The cells 10 and the cushioning members 11 in a third and subsequent groups may be further overlapped. In this case, the guide module 44 is connected to the guide 41B, and the guide is appropriately extended.

Then, an upper end plate 3b is overlapped on the laminate 12 in which all the cells 10 and the cushioning members 11 are laminated. Similarly to the lower end plate 3a, the upper end plate 3b is also provided with a plurality of guide holes, and each of the guides 41B is inserted into a corresponding guide hole among the plurality of guide holes of the upper end plate 3b. The upper end plate 3b is moved downward along the guides 41B from the upper end of each guide 41B and overlapped on the laminate 12.

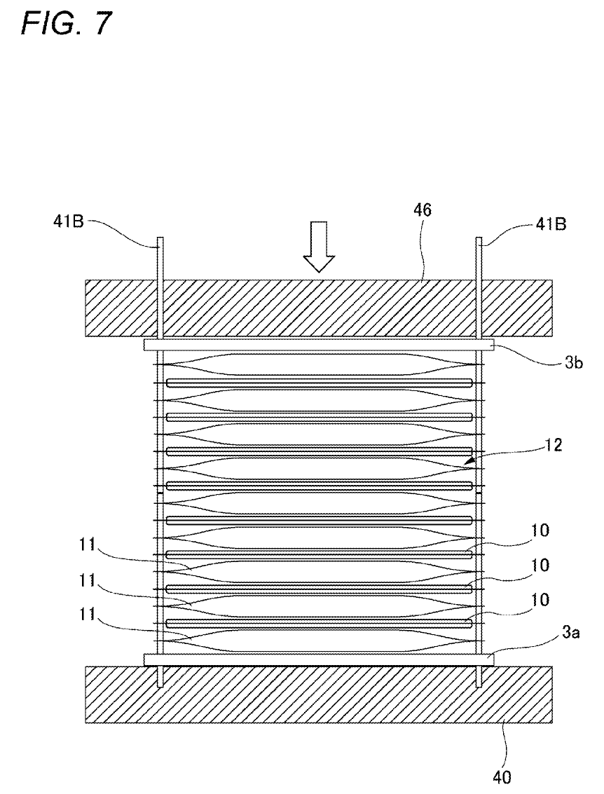

Next, as shown in FIG. 7, the laminate 12 is compressed. A pressurizing jig 46 is overlapped on the upper end plate 3b. The pressurizing jig 46 is provided with a plurality of guide holes, and each of the guides 41B is inserted into a corresponding guide hole among the plurality of guide holes of the pressurizing jig 46. The pressurizing jig 46 is moved downward along the guides 41B from the upper end of each guide 41B and is overlapped on the upper end plate 3b. Then, by the compression device, the base 40 is supported, the pressurizing jig 46 is pushed down, and the laminate 12 is compressed to a predetermined thickness.

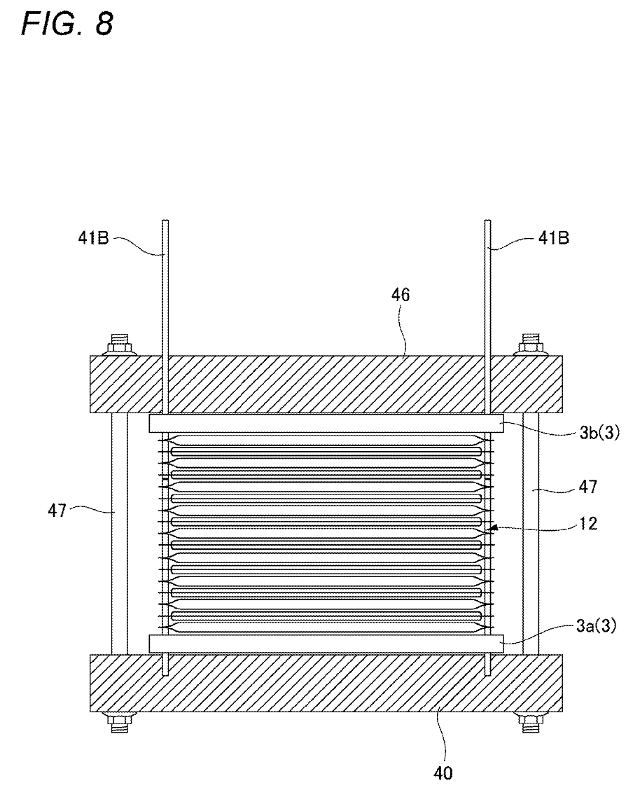

Next, as shown in FIG. 8, the base 40 and the pressurizing jig 46 are restrained to each other by appropriate fixing jigs 47. Even after an interval between the base 40 and the pressurizing jig 46 is fixed and the pressurization of the pressurizing jig 46 is released, the laminate 12 is kept in a compressed state. Thereafter, the compressed laminate 12 and the set of end plates 3 sandwiching the laminate 12 are carried out from the compression device together with the base 40 and the pressurizing jig 46, and the frames 4 are assembled to the set of end plates 3 to form the battery 1.

After the frames 4 are assembled to the set of end plates 3, the restraint of the base 40 and the pressurizing jig 46 implemented by the fixing jigs 47 is released, and the pressurizing jig 46 is removed. Then, the battery 1 is lifted up along the guides 41B and removed from the base 40.

In the manufacturing method shown in FIGS. 4 to 8, the cells 10 and the cushioning members 11 in the first group are disposed on a lower layer side in the laminate 12 of the battery 1. The guide 41A when the cells 10 and the cushioning members 11 in the first group are laminated is shorter than the guide 41B required for laminating all the cells 10 and the cushioning members 11, and thus a time and effort for moving the cells 10 and the cushioning members 11 in the first group to a predetermined position on the lower layer side along the guides 41A is reduced. Accordingly, assemblability of the battery 1 can be improved.

Further, when compressing the laminate 12, the cells 10 and the cushioning members 11 constituting the laminate 12 are prevented from being displaced in a direction intersecting the laminating direction by the engagement with the guides 41B inserted into the guide holes 20 and the guide holes 30. Accordingly, the laminate 12 can be compressed while maintaining a state in which the cells 10 and the cushioning members 11 are aligned in the laminating direction, and assembling of the frames 4 is facilitated.

Further, by compressing the laminate 12 while maintaining the state in which the cells 10 and the cushioning members 11 are aligned in the laminating direction, each in-plane location (perpendicular to the thickness direction of the cells 10) can be uniformly pressed. This is useful when the cell 10 is a cell using the solid electrolyte, and is useful when the cell 10 includes a negative electrode made of the metallic lithium or the like.

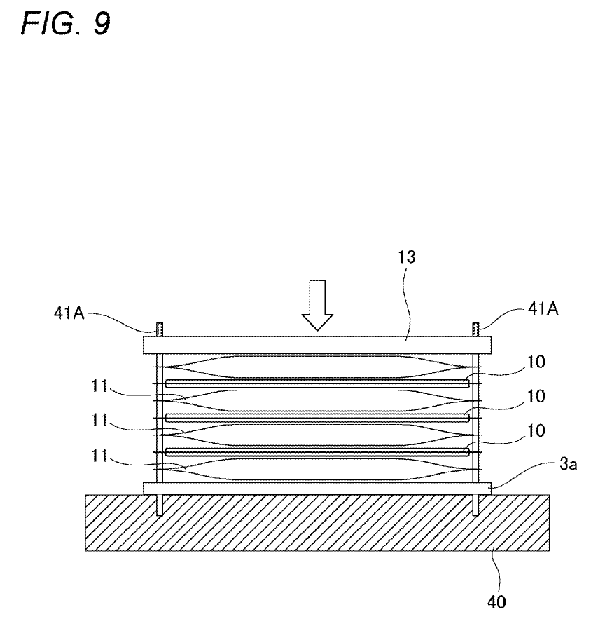

FIGS. 9 to 11 show a modification of the method for manufacturing the battery 1. In a manufacturing method to be described below, each time the cells 10 and the cushioning members 11 in one group are laminated along the guides, a laminate including the laminated cells 10 and cushioning members 11 is compressed.

First, as shown in FIG. 9, the lower end plate 3a is overlapped on the base 40, and the cells 10 and the cushioning members 11 in the first group are overlapped on the lower end plate 3a. Further, an intermediate plate 13 is overlapped on a laminate including the laminated cells 10 and cushioning members 11 in the first group. The intermediate plate 13 is provided with a plurality of guide holes, and each of the guides 41A is inserted into a corresponding guide hole among the plurality of guide holes of the intermediate plate 13.

Then, by the compression device, the base 40 is supported, the intermediate plate 13 is pushed down, and the laminate including the laminated cells 10 and cushioning members 11 in the first group is compressed to a predetermined thickness. After the compression, a position of the intermediate plate 13 with respect to the base 40 is fixed by an appropriate method. For example, a bolt may be inserted into a screw hole reaching the guide hole of the intermediate plate 13 from a side surface of the intermediate plate 13, and the bolt may be engaged with the guide 41A.

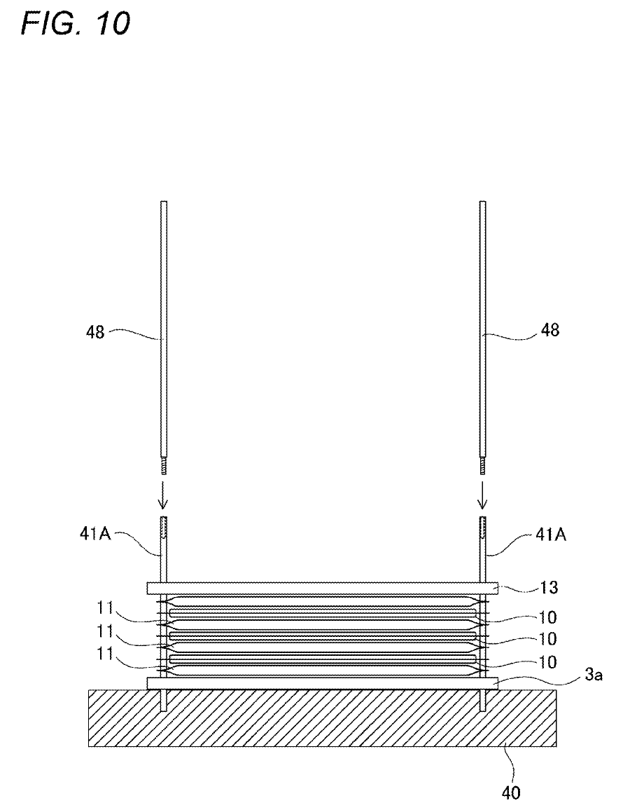

Next, as shown in FIG. 10, a guide module 48 is connected to the upper end portion of each of the guides 41A. The guide module 48 is integrated with the guide 41A to form a guide 41C extended from the guide 41A.

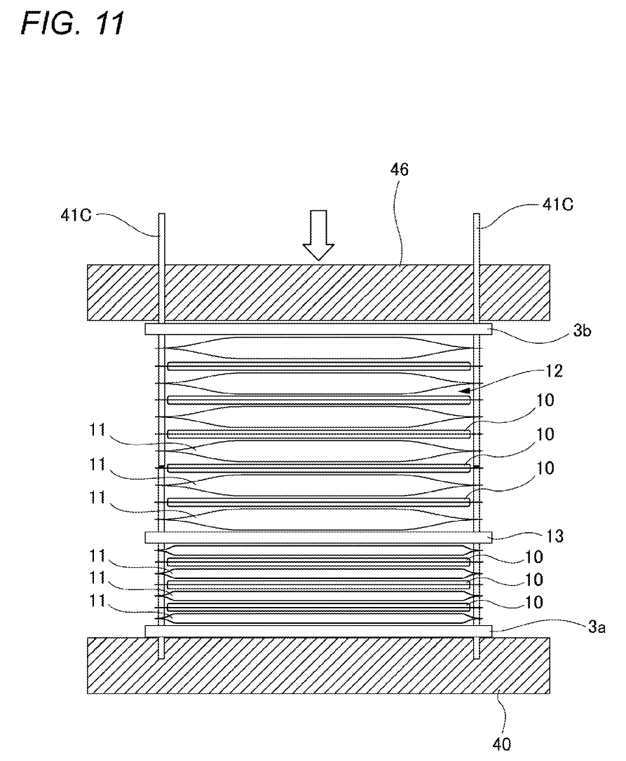

Next, as shown in FIG. 11, the cells 10 and the cushioning members 11 in the second group and the upper end plate 3b are overlapped on the intermediate plate 13. Thereafter, as shown in FIGS. 7 and 8, the pressurizing jig 46 is overlapped on the upper end plate 3b, and by the compression device, the base 40 is supported, the pressurizing jig 46 is pushed down, and the laminate 12 is compressed to a predetermined thickness. Then, the base 40 and the pressurizing jig 46 are restrained to each other by the appropriate fixing jigs 47, and the frames 4 are assembled to the compressed laminate 12 and the set of end plates 3 sandwiching the laminate 12, thereby constituting the battery 1.

According to the manufacturing method shown in FIGS. 9 to 11, in a stage when the cells 10 and the cushioning members 11 in the first group are laminated, the laminate including the cells 10 and the cushioning members 11 is compressed. The guide 41C required for laminating all the cells 10 and cushioning members 11 including the cells 10 and the cushioning members 11 in the second group to be laminated later can be shortened as compared with the guide 41B. Accordingly, the compression device can be downsized.

The embodiment of the present invention has been described above, but the present invention is not limited to the embodiment described above, and modifications, improvements, and the like can be made as appropriate. In the present description, at least the following matters are described. Although corresponding constituent elements or the like in the embodiment described above are shown in parentheses, the present invention is not limited thereto.

(1) A method for manufacturing a battery (battery 1) in which a plurality of cushioning members (cushioning members 11) and a plurality of cells (cells 10) each disposed between adjacent two of the cushioning members are laminated, the method including:

laminating the plurality of cells and the plurality of cushioning members by engaging a guide-engaging portion (guide hole 20) of each of the cells and a guide-engaging portion (guide hole 30) of each of the cushioning members with a guide (guides 41A, 41B) extending in a laminating direction of the plurality of cells and the plurality of cushioning members, in which

when laminating the plurality of cells and the plurality of cushioning members, the plurality of cells and the plurality of cushioning members are divided into a plurality of groups including a first group including one or more of the cells and two or more of the cushioning members and a second group including one or more of the cells and two or more of the cushioning members, and

the cells and the cushioning members in the first group are laminated along the guide,

a guide module (guide module 44) is connected to the guide to extend the guide in the laminating direction, and

the cells and the cushioning members in the second group are overlapped and laminated on the cells and the cushioning members in the first group along the extended guide.

According to the method for manufacturing the battery in the above (1), the guide when the cells and the cushioning members in the first group are laminated is shorter than the guide required for laminating all the cells and the cushioning members, and thus a time and effort for moving the cells and the cushioning members in the first group to a predetermined position on a lower layer side along the guide is reduced. Accordingly, assemblability of the battery can be improved. Further, when compressing the laminate, the cells and the cushioning members constituting the laminate are prevented from being displaced in a direction intersecting the laminating direction by the engagement with the guide. Accordingly, the laminate can be compressed while maintaining a state in which the cells and the cushioning members are aligned in the laminating direction, and each in-plane location (perpendicular to a thickness direction of the cells) can be uniformly pressed.

(2) The method for manufacturing the battery according to the above (1), in which

fixing elements (female thread 43, male thread 45) to be fixed to each other are respectively formed at one end portion of the guide (guide 41A) to which the guide module is to be connected and one end portion of the guide module to be connected to the guide.

According to the method for manufacturing the battery in the above (2), the connection between the guide and the guide module is easy.

(3) The method for manufacturing the battery according to the above (2), in which

the other end portion of the guide is fixed to a base (base 40) that supports the plurality of cells and the plurality of cushioning members in the laminating direction.

According to the method for manufacturing the battery in the above (3), a configuration of a jig including the guide can be simplified.

(4) The method for manufacturing the battery according to the above (1), in which

the guide-engaging portion of each of the cells and the guide-engaging portion of each of the cushioning members are holes through which the guide is to be inserted.

According to the method for manufacturing the battery in the above (4), the cells and the cushioning members can be reliably engaged with the guide.

(5) The method for manufacturing the battery according to the above (1), in which

the cells and the cushioning members in the second group are overlapped and laminated on the cells and the cushioning members in the first group, and

the cells and the cushioning members in the first group and the cells and the cushioning members in the second group are compressed in the laminating direction.

According to the method for manufacturing the battery in the above (5), the number of compression steps can be reduced.

(6) The method for manufacturing the battery according to the above (1), in which

the cells and the cushioning members in the first group which are laminated along the guide are compressed in the laminating direction, and

the cells and the cushioning members in the second group are overlapped and laminated on the compressed cells and cushioning members in the first group and compressed in the laminating direction.

According to the method for manufacturing the battery in the above (6), a length of the guide required for laminating all the cells and the cushioning member is shortened, and a compression device can be downsized.

(7) The method for manufacturing the battery according to any one of the above (1) to (6), in which

each of the cells includes a solid electrolyte.

(8) The method for manufacturing the battery according to any one of the above (1) to (6), in which

a negative electrode of each of the cells contains metallic lithium or an alloy containing metallic lithium.

(9) The method for manufacturing the battery according to any one of the above (1) to (6), in which

a negative electrode of each of the cells contains silicon.

(10) The method for manufacturing the battery according to any one of the above (1) to (6), in which

each of the cushioning members includes a fluid sealed in a packaging material.

### REFERENCE SIGNS LIST

1 battery

3 end plate

4 frame

10 cell

11 cushioning member

12 laminate

13 intermediate plate

20 guide hole

30 guide hole

40 base

41A guide

41B guide

41C guide

42 lower end portion

43 female thread

44 guide module

45 male thread

46 pressurizing jig

47 fixing jig

What is claimed is:

1. A method for manufacturing a battery in which a plurality of cushioning members and a plurality of cells each disposed between adjacent two of the cushioning members are laminated, the method comprising:
laminating the plurality of cells and the plurality of cushioning members by engaging a guide-engaging portion of each of the cells and a guide-engaging portion of each of the cushioning members with a guide extending in a laminating direction of the plurality of cells and the plurality of cushioning members, wherein
when laminating the plurality of cells and the plurality of cushioning members, the plurality of cells and the plurality of cushioning members are divided into a plurality of groups including a first group including one or more of the cells and two or more of the cushioning members and a second group including one or more of the cells and two or more of the cushioning members, and
the cells and the cushioning members in the first group are laminated along the guide,
a guide module is connected to the guide to extend the guide in the laminating direction, and
the cells and the cushioning members in the second group are overlapped and laminated on the cells and the cushioning members in the first group along the extended guide.

2. The method for manufacturing the battery according to claim 1, wherein
fixing elements to be fixed to each other are respectively formed at one end portion of the guide to which the guide module is to be connected and one end portion of the guide module to be connected to the guide.

3. The method for manufacturing the battery according to claim 2, wherein
other end portion of the guide is fixed to a base that supports the plurality of cells and the plurality of cushioning members in the laminating direction.

4. The method for manufacturing the battery according to claim 1, wherein
the guide-engaging portion of each of the cells and the guide-engaging portion of each of the cushioning members are holes through which the guide is to be inserted.

5. The method for manufacturing the battery according to claim 1, wherein
the cells and the cushioning members in the second group are overlapped and laminated on the cells and the cushioning members in the first group, and
the cells and the cushioning members in the first group and the cells and the cushioning members in the second group are compressed in the laminating direction.

6. The method for manufacturing the battery according to claim 1, wherein
the cells and the cushioning members in the first group which are laminated along the guide are compressed in the laminating direction, and
the cells and the cushioning members in the second group are overlapped and laminated on the compressed cells and cushioning members in the first group and compressed in the laminating direction.

7. The method for manufacturing the battery according to claim 1, wherein
each of the cells includes a solid electrolyte.

8. The method for manufacturing the battery according to claim 2, wherein
each of the cells includes a solid electrolyte.

9. The method for manufacturing the battery according to claim 3, wherein
each of the cells includes a solid electrolyte.

10. The method for manufacturing the battery according to claim 4, wherein
each of the cells includes a solid electrolyte.

11. The method for manufacturing the battery according to claim 1, wherein
a negative electrode of each of the cells contains metallic lithium or an alloy containing metallic lithium.

12. The method for manufacturing the battery according to claim 2, wherein
a negative electrode of each of the cells contains metallic lithium or an alloy containing metallic lithium.

13. The method for manufacturing the battery according to claim 3, wherein
a negative electrode of each of the cells contains metallic lithium or an alloy containing metallic lithium.

14. The method for manufacturing the battery according to claim 4, wherein
a negative electrode of each of the cells contains metallic lithium or an alloy containing metallic lithium.

15. The method for manufacturing the battery according to claim 1, wherein
a negative electrode of each of the cells includes silicon.

16. The method for manufacturing the battery according to claim 2, wherein
a negative electrode of each of the cells includes silicon.

17. The method for manufacturing the battery according to claim 3, wherein
a negative electrode of each of the cells includes silicon.

18. The method for manufacturing the battery according to claim 4, wherein
a negative electrode of each of the cells includes silicon.

19. The method for manufacturing the battery according to claim 1, wherein
each of the cushioning members includes a fluid sealed in a packaging material.

20. The method for manufacturing the battery according to claim 2, wherein
each of the cushioning members includes a fluid sealed in a packaging material.
